(19) United States
(12) Patent Application Publication
(10) Pub. No.: US 2015/0081405 A1
(43) Pub. Date: Mar. 19, 2015

(54) FINANCIAL HEALTH ASSESSMENT AND INCENTIVE SYSTEM FOR FINANCIALLY RESPONSIBLE BEHAVIORS

(71) Applicant: BANK OF AMERICA CORPORATION, Charlotte, NC (US)

(72) Inventors: Erik Stephen Ross, Charlotte, NC (US); Katherine Ann Krumme, San Francisco, CA (US)

(21) Appl. No.: 14/550,628

(22) Filed: Nov. 21, 2014

Related U.S. Application Data
(63) Continuation of application No. 13/218,024, filed on Aug. 25, 2011.

(51) Int. Cl. G06Q 30/02; G06Q 50/00; G06Q 40/00

(52) U.S. Cl. CPC G06Q 30/0207; G06Q 40/00; G06Q 50/01
USPC 705/14.1

(57) ABSTRACT

Embodiments of the invention provide financial health assessment and incentive systems for financially responsible behaviors. The methods, apparatus and computer program products provide for receiving a financial behavior set associated with a customer, identifying a difference between the financial behavior set associated with the customer and a second financial behavior set, and providing to the customer an incentive to make an alteration to a financial behavior. In some example implementations, financial behaviors exhibited by or otherwise attributable to individuals who are socially affiliated with the customer via a social network are observed and associated with the customer. In some example implementations, advertisements for goods and/or services that are potentially attractive to the customer are directed to the customer in response to identifying a difference between the financial behavior set associated with the customer and the second financial behavior set.

### CROSS-REFERENCE TO RELATED APPLICATIONS

This application is a continuation of co-pending U.S. application Ser. No. 13/218,024 entitled “Financial Health Assessment and Incentive System for Financially Responsible Behaviors” (filed Aug. 25, 2011), which published on Feb. 28, 2013, as U.S. Patent Application Publication No. 2013-0054314, which is hereby incorporated by reference in its entirety.

### FIELD

In general, embodiments of the invention relate to customer assessment and service in the financial sector, and, more particularly, methods, devices and computer program products for implementing a financial health assessment and incentive system that incorporates information regarding a financial behavior set associated with a customer to identify financial behaviors of interest and to provide incentives and opportunities to the customer that encourage alterations to such behaviors.

### BACKGROUND

The market for financial services is a highly varied, diverse, competitive and complex market, where customers have an almost limitless array of options for borrowing, lending, saving, spending, investing, and otherwise using money. In such a varied and competitive market, it is not uncommon for an individual to be a customer of many different, independent financial institutions. For example, a person may have a checking account with one bank, a savings account with another, several credit cards each administered by a different entity, a mortgage with a community lender, a retirement account with an investment bank, and an online stock trading account serviced by yet another entity.

While the opportunity for an individual to select from such a wide array of financial institutions provides the customer with the appearance of choice, the tendency among some customers to distribute their business among a number of financial institutions can limit the ability of those financial institutions to accurately gauge the customer's needs and make the customer aware of additional appropriate products and services, or provide advice that accurately reflects the needs or goals of the customer.

From the perspective of a financial institution, the information that an institution can access regarding a customer's overall financial health and well-being is often limited to the information about the account held by the customer with that particular institution. Consequently, it can be difficult for a financial institution to gain an accurate perspective of a customer's overall financial behaviors. The limited perspective and limited ability to assess a customer's financial health can be particularly problematic when a customer appears to be engaging in what may be considered irresponsible or otherwise ill-advised financial behaviors. In situations where a customer overdraws an account or otherwise incurs a fee, the financial institution risks both the loss of revenue associated with the financial behavior, and a decrease in customer satisfaction. Further, the limited information viewable by the financial institution limits the ability of that institution to identify what, if any behaviors represent the cause of a customer's potential financial difficulties, and limits the institution's ability to encourage a change in such behaviors.

The popularity and prevalence of Internet-based social networking websites has increased in parallel with the expansion and diversification of the financial services industry. Now more than ever, individuals have become increasingly comfortable initiating and maintaining social relationships through the use of social networking websites such as Facebook®, LinkedIn®, and other such entities. As a result, individuals within a social network are able to receive information and suggestions from other people within their social network about financial behaviors and related products, and social pressures regarding financial behaviors can be exerted from an ever-expanding network of people. However, while the exchange of such information has become easier, the behaviors modeled or suggested by individuals within a social network are often inapplicable or inadvisable for a customer within a social network.

Therefore, a need exists to develop methods, apparatus, computer program products and the like that provide for financial health assessment and incentive systems for financially responsible behaviors.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

Thus, further details are provided below for a financial health assessment and incentive system for financially responsible behaviors. The methods, apparatus and computer program products herein described provide for identifying one or more differences between a first financial behavior set associated with a customer and a second financial behavior set, and providing the customer with an incentive to alter their behaviors to reduce the difference between those sets. Some of the described embodiments take into account financial behaviors that are not directly observable by a single financial institution, including, for example, financial behaviors that are present in the customer's social network. Other described embodiments provide for an advertisement to be directed to the customer and individuals in the customer's social network.

Example embodiments in accordance with one aspect of the invention provide for an apparatus for assessing and incentivizing a financial behavior associated with a customer. In such embodiments, the apparatus includes a computing device including a memory and at least one processor; and a customer financial behavior assessment application stored in memory, executable by the processor, and configured to receive a first financial behavior set associated with a customer, identify one or more differences between the first financial behavior set and a second financial behavior set, and provide to the customer an incentive to make an alteration to a financial behavior in the first financial behavior set, wherein the incentive is configured to reduce the one or more differences between the first financial behavior set and the second financial behavior set.

In some implementations of such embodiments, the financial behavior assessment application is further configured to obtain information associated with a plurality of accounts wherein the plurality of accounts includes a first account associated with a first institution, and a second account associated with a second institution. In some such example implementations, the first financial behavior set includes at least one aspect selected from the group consisting of a spending behavior, a savings behavior, a financial goal associated with the customer, a budgeting behavior, and a credit behavior. In other example implementations, the apparatus is configured such that the first financial behavior set includes a behavior associated with an individual, wherein the individual is socially affiliated with the customer via a social network.

Other example embodiments are also described herein, including embodiments where the apparatus is configured such that the second financial behavior set includes at least one aspect selected from the group consisting of a spending behavior, a savings behavior, a financial goal associated with the customer, a budgeting behavior, and a credit behavior. Some additional example implementations provide for an apparatus wherein the second financial behavior set includes a financial behavior set associated with an individual wherein the individual is socially affiliated with the customer via a social network.

Moreover, in additional example embodiments of the apparatus, the financial behavior assessment application is further configured to offer the customer at least one incentive selected from the list consisting of: a reduced interest rate on a loan, an opportunity to enter a prize drawing, forgiveness of a fee charged on an account, and an award.

In still other example embodiments of the apparatus, the financial behavior assessment application is further configured to receive a third financial behavior set, wherein the third financial behavior set is associated with the customer, and the financial behavior assessment application is further configured to identify one or more differences between the third financial behavior set and the second financial behavior set. In example implementations of such embodiments, the financial behavior assessment application is further configured to, in response to identifying one or more differences between the third financial behavior set and the second financial behavior set, adjust the incentive provided to the customer.

Additional embodiments are also described herein, including embodiments wherein the financial behavior assessment application is further configured to, in response to identifying one or more differences between the first financial behavior set and a second financial behavior set, direct an advertisement to the customer. In some example implementations of such embodiments of the apparatus, the financial behavior assessment application is further configured to identify a plurality of individuals wherein each individual in the plurality of individuals is socially affiliated with the customer via a social network and direct the advertisement to an individual in the plurality of individuals.

Example embodiments in accordance with another aspect of the invention provide methods for assessing and incentivizing a financial behavior associated with a customer, the method including receiving a first financial behavior set associated with a customer, identifying via a computing device processor one or more differences between the first financial behavior set and a second financial behavior set, and providing to the customer an incentive to make an alteration to a financial behavior in the first financial behavior set, wherein the incentive is configured to reduce the one or more differences between the first financial behavior set and the second financial behavior set. In some example implementations of such methods, receiving the first financial behavior set associated with a customer includes obtaining information associated with a plurality of accounts wherein the plurality of accounts comprises a first account associated with a first institution, and a second account associated with a second institution.

In some example methods, the first financial behavior set includes at least one aspect selected from the group consisting of a spending behavior, a savings behavior, a financial goal associated with the customer, a budgeting behavior, and a credit behavior. In other example methods, the first financial behavior set includes a behavior associated with an individual, wherein the individual is socially affiliated with the customer via a social network.

Other example implementations of methods are described herein wherein the second financial behavior set includes at least one aspect selected from the group consisting of a spending behavior, a savings behavior, a financial goal associated with the customer, a budgeting behavior, and a credit behavior In other example methods, the second financial behavior set comprises a financial behavior set associated with an individual wherein the individual is socially affiliated with the customer via a social network.

In some example implementations, providing to the customer an incentive to make an alteration to a financial behavior in the first financial behavior set, wherein the incentive is configured to reduce the difference between the first financial behavior set and the second financial behavior set includes offering the customer at least one incentive selected from the list consisting of: a reduced interest rate on a loan, an opportunity to enter a prize drawing, forgiveness of a fee charged on an account, and an award.

In other example implementations, methods in accordance with an aspect of the invention further include, responsive to providing to the customer an incentive to make an alteration to a financial behavior in the first financial behavior set, wherein the incentive is configured to reduce the difference between the first financial behavior set and the second financial behavior set, receiving a third financial behavior set, wherein the third financial behavior set is associated with the customer and identifying via a computing device processor one or more differences between the third financial behavior set and the second financial behavior set. In some example implementations of such methods, the methods further include, responsive to identifying via a computing device processor one or more differences between the third financial behavior set and the second financial behavior set, adjusting the incentive provided to the customer.

Moreover, additional example implementations include, in response to identifying via a computing device processor one or more differences between the first financial behavior set and a second financial behavior set, directing an advertisement to the customer. In some example implementations of such methods, the methods further include identifying a plurality of individuals wherein each individual in the plurality of individuals is socially affiliated with the customer via a social network, and directing the advertisement to an individual in the plurality of individuals.

Example embodiments in accordance with a third aspect of the invention provide computer program product including a non-transitory computer-readable medium including a first set of codes for causing a computer processor to be configured for receiving a first financial behavior set associated with a customer, a second set of codes for causing a computer processor to be configured for identifying via a computing device processor one or more differences between the first financial behavior set and a second financial behavior set, and a third set of codes for causing a computer processor to be configured for providing to the customer an incentive to make an alteration to a financial behavior in the first financial behavior set, wherein the incentive is configured to reduce the one or more differences between the first financial behavior set and the second financial behavior set.

In some example implementations of a computer program product, the first financial behavior set associated with a customer comprises obtaining information associated with a plurality of accounts wherein the plurality of accounts comprises a first account associated with a first institution, and a second account associated with a second institution.

In other example implementations the first financial behavior set includes at least one aspect selected from the group consisting of a spending behavior, a savings behavior, a financial goal associated with the customer, a budgeting behavior, and a credit behavior. In other example implementations of a computer program product, the first financial behavior set comprises a behavior associated with an individual, wherein the individual is socially affiliated with the customer via a social network.

In additional example implementations of a computer program product, the second financial behavior set includes at least one aspect selected from the group consisting of a spending behavior, a savings behavior, a financial goal associated with the customer, a budgeting behavior, and a credit behavior. In other example implementations, the second financial behavior set comprises a financial behavior set associated with an individual wherein the individual is socially affiliated with the customer via a social network.

In other implementations of a computer program product, providing to the customer an incentive to make an alteration to a financial behavior in the first financial behavior set, wherein the incentive is configured to reduce the difference between the first financial behavior set and the second financial behavior set comprises offering the customer at least one incentive selected from the list consisting of: a reduced interest rate on a loan, an opportunity to enter a prize drawing, forgiveness of a fee charged on an account, and an award.

Additional example implementations of a computer program product include a fourth set of codes for causing a computer processor to be configured for, responsive to providing to the customer an incentive to make an alteration to a financial behavior in the first financial behavior set, wherein the incentive is configured to reduce the difference between the first financial behavior set and the second financial behavior set, receiving a third financial behavior set, wherein the third financial behavior set is associated with the customer, and identifying one or more differences between the third financial behavior set and the second financial behavior set.

In some example implementations of such computer program products, the computer program products further include a fifth set of codes for causing a computer processor to be configured for, responsive to identifying one or more differences between the third financial behavior set and the second financial behavior set, adjusting the incentive provided to the customer.

Additional example implementations of a computer program product further include a set of codes for causing a computer processor to be configured for, responsive to identifying via a computing device processor one or more differences between the first financial behavior set and a second financial behavior set, directing an advertisement to the customer. In some such example implementations, the computer program product further includes a set of codes for causing a computer processor to be configured for identifying a plurality of individuals wherein each individual in the plurality of individuals is socially affiliated with the customer via a social network, and a set of codes for causing a computer processor to be configured for directing the advertisement to an individual in the plurality of individuals.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIG. 1 is a simplified schematic diagram of a social network as contemplated by example embodiments of an aspect of the invention.

FIG. 2 is a schematic diagram of a system configured to implement example embodiments of an aspect of the invention.

FIG. 3 is a simplified block diagram of a process flow in accordance with example embodiments of one aspect of the invention.

FIG. 4 is a more detailed block diagram of a process flow in accordance with example embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, or device. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, further details are provided below for apparatuses, methods, and computer program products representing example implementations of embodiments of the present invention.

Some such embodiments contemplate a customer and a financial behavior set associated with that customer. As used herein, the term financial behavior set means any set of behaviors, goals, actions, plans, resources, attributes, characteristics, traits, or other factors that impact or have the potential to impact the financial health of a customer. As contemplated herein, a financial behavior set may include set elements that are directly attributable to the customer, and elements that are indirectly attributable to the customer.

While some aspects of such a financial behavior set may be directly observable by an individual entity, such as a single financial institution, many behaviors within a comprehensive behavior set may be indirectly observable by a particular entity, or altogether unobservable by that same entity. For example, in situations where a customer utilizes financial services from multiple disparate service providers, the use or status of a customer's account, loan, credit facility, or other financial product at one entity may be unknown to another entity. In other examples, such as situations where a financial institution provides multiple financial services but maintains at least some level of independence or differentiation between business units that each provide a particular subset of services, a similar issue can arise where one business unit is unaware of the use or status of products and services provided to the customer by another business unit.

Consequently, in some implementations of the embodiments described herein, the financial behavior set incorporates set elements derived from a plurality of sources. For example, one financial institution may invite a customer to provide the institution with additional information about the usage and status of accounts held at other financial institutions, such as credit card accounts, mortgages, student loans, business loans, personal loans, savings accounts, or other financial services or products. Similarly, a customer may provide information about their spending habits, savings habits, financial goals, household budget, and other aspects pertaining to the customer's financial actions and/or intentions.

Embodiments of the present invention also contemplate a second financial behavior set, and the ability to identify one or more differences between the financial behavior set associated with the customer and the second financial behavior set. In some such example implementations, the differences between the financial behavior set associated with the customer and the second financial behavior set provide a basis to assess the financial health of the customer. For example, in implementations where the second financial behavior set represents a desirable set of behaviors, or a set of behaviors that are correlated with good financial health, instances where the financial behavior set associated with the customer does not match the second financial behavior set may indicate that the customer is engaged in suboptimal or otherwise detrimental financial behaviors. Such suboptimal or detrimental behaviors may include failing to pay bills on time, excessive spending, insufficient saving, overdrawing a particular account, defaulting on loans, or other behaviors inconsistent with sound financial principles.

Embodiments of the present invention also contemplate providing the customer with an incentive to make an alteration to a financial behavior in the financial behavior set associated with the customer that reduces one or more differences between the financial behavior set associated with the customer and the second financial behavior set. In some example implementations, an incentive may have the effect of inducing the customer to reduce or altogether cease suboptimal or otherwise detrimental financial behaviors.

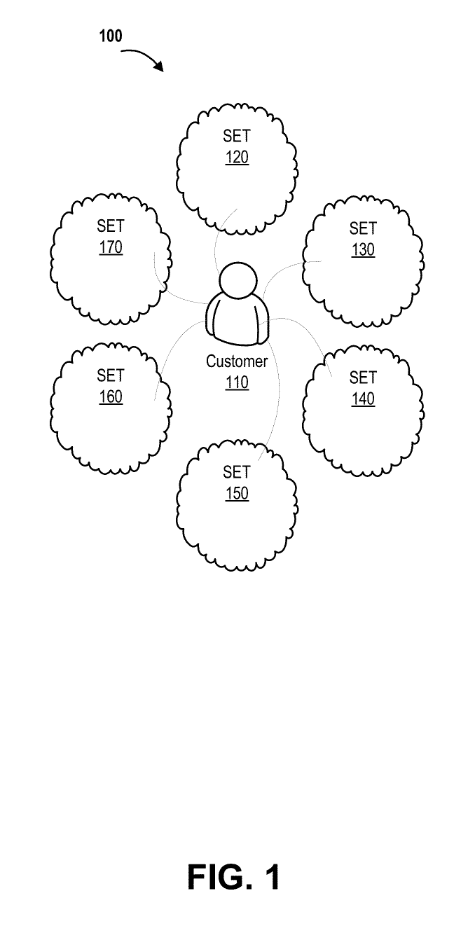

Some example embodiments described herein contemplate a social network that includes the customer and individuals who are socially affiliated with the customer. As shown in FIG. 1, social network 100 includes a customer 110, who is a customer of an entity, such as a financial institution, and a plurality of sets of individuals 120, 130, 140, 150, 160, and 170 wherein each set of individuals 120-170 is socially affiliated with the customer 110. For the sake of clarity, interconnections amongst and between individuals in each set of individuals 120-170 have been omitted, as have interconnections amongst and between sets 120-170 themselves. However, it will be appreciated that sets of individuals such as those depicted as sets 120-170 and individuals within each set may be socially affiliated with other individuals. As depicted in FIG. 1, each of the sets of individuals 120-170 is socially affiliated with the customer 110. For example, a set of individuals may represents the customer's friends, family members, other relatives, acquaintances, coworkers, current or former classmates, neighbors, individuals who belong to a religious organization or other community organization, connections made via online social networking websites such as Facebook® or LinkedIn®, customers, or any other set of individuals socially affiliated with the customer 110.

While there are many Internet-based examples of social networks, such as Facebook®, LinkedIn®, and other social networking websites, it will be appreciated that as used herein, the term social network refers to any individual or sets of individuals, such as those shown as sets 120-170, that are socially affiliated with a customer, such as customer 110.

In some example embodiments presented herein, it is contemplated that financial behaviors or traits exhibited or present in a customer's social network may have an impact on the customer's financial behaviors or traits. For example, if a customer's family and friends exhibit positive financial behaviors, such as prudent investing, timely payment of bills, appropriate levels of saving, and conscientious management of credit, it is possible that the customer will be more likely to exhibit those same positive behaviors to a greater degree than an individual whose social network shows a lower prevalence of good financial behaviors or a higher prevalence of negative financial behaviors.

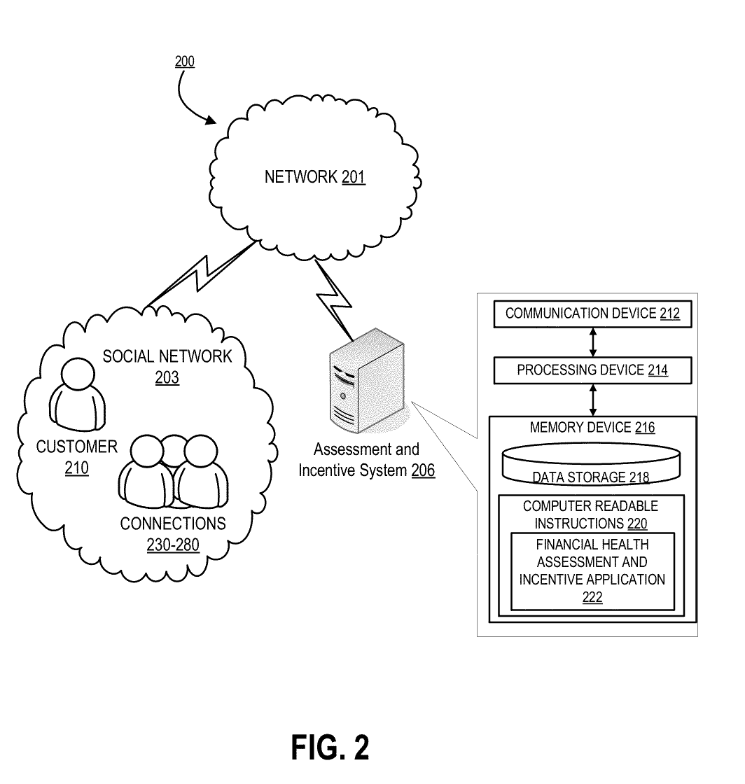

FIG. 2 depicts financial health assessment and incentive system and environment 200, in accordance with an aspect of the invention. As shown in FIG. 2, the assessment and incentive system 206 is operatively coupled, via a network 201 to the social network 203, and can send and receive information to and from the social network 203, such that the assessment and incentive system can passively receive information, actively seek information, and active transmit information to the network 201 and the social network 203. It will be appreciated that FIG. 2 illustrates only one example of financial health assessment and incentive system and environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination of wireline and wireless communication between devices on the network.

As shown in FIG. 2, customer 210 is present in the financial health assessment and incentive system and environment 200. It will be appreciated that customer 202 may have any of the aspects and traits of the customer 110 as presented in FIG. 1 and otherwise discussed herein. In some embodiments, customer 210 is the holder and/or user of an account with financial institution or other entity that maintains and/or services customer accounts.

As shown in FIG. 2, the social network 203 is operatively coupled to the assessment and incentive system 206, and the assessment and incentive system may access the social network 203. The social network 203 generally refers to any social structure made up of individuals or organizations which are connected by one or more specific types of interdependencies, such as kinship, friendship, common interest, financial exchanges, working relationships, dislikes, relationships, beliefs, knowledge, prestige, geographic proximity, and/or the like. The social network may be a web-based social structure or a non-web-based social structure. In some embodiments, the social network may be inferred from financial transaction behavior, mobile device behaviors, etc. In this way, the social network 203 may be unique pages of the customer 210 on already-existing social networks such as Facebook®, Twitter®, Linkedin®, YouTube®, as well as any one or more existing web logs, blogs, forums, and/or other social spaces. It will also be appreciated that social network 203 may have any of the aspects of the social network 100 depicted in FIG. 1, and described elsewhere herein. For clarity, connections 220-270 have been condensed into a single icon, but it will be appreciated that connections 230-280 may include any of the aspects of sets 120-170 as described herein with relation to FIG. 1.

In some embodiments, the assessment and incentive system 206 may be associated with the financial institution or other entity that maintains and/or services customer accounts. For example, a financial institution may establish and/or control the assessment and incentive system 206 to allow the entity to send and receive information via network 201, including information relating to the customer 210 and the social network 203.

As shown in FIG. 2, the assessment and incentive system 206 generally comprises a communication device 212, a processing device 214, and a memory device 216. As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 214 is operatively coupled to the communication device 212 and the memory device 216. The processing device 214 uses the communication device 212 to communicate with the network 201 and other devices on the network 201, such as, but not limited to the social network 203. As such, the communication device 214 generally comprises a modem, server, or other device for communicating with other devices on the network 201.

As illustrated in FIG. 2, the assessment and incentive system 206 comprises computer-readable instructions 220 stored in the memory device 216, which in one embodiment includes computer-readable instructions 220 for a financial health assessment and incentive application 222. In some embodiments, the memory device 216 includes data storage 218 for storing data related to the financial health assessment and incentive system 200 including, but not limited to the data created and/or used by the call center application 222.

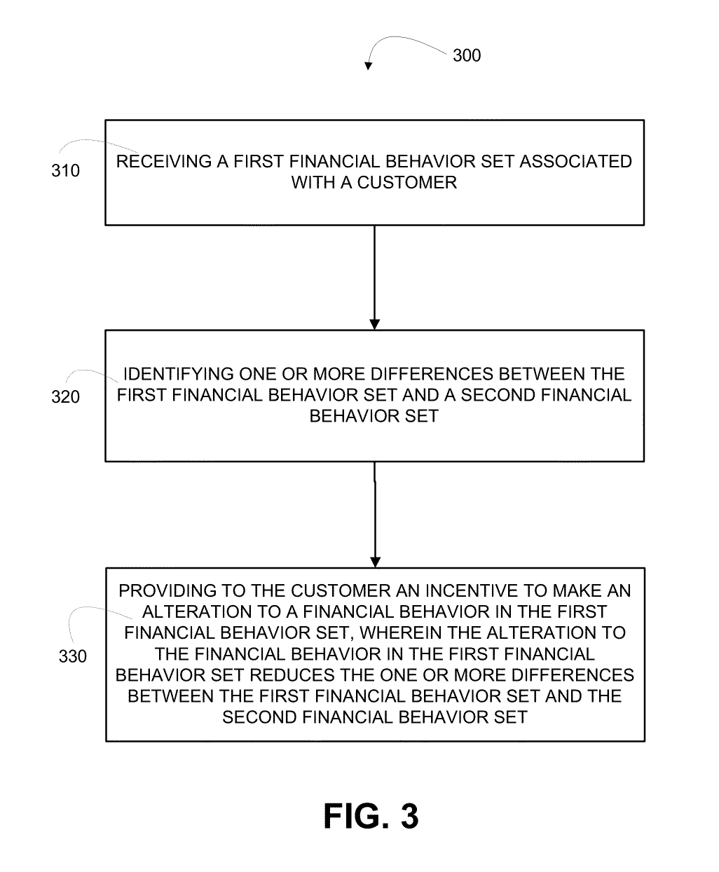

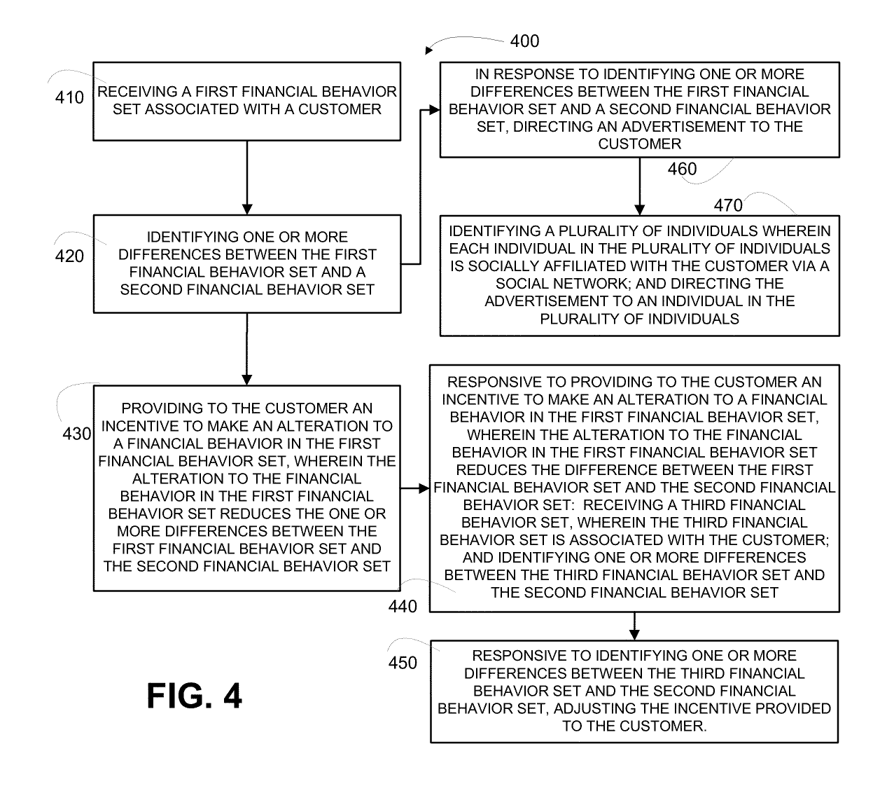

As illustrated in FIG. 2 and described throughout much of this specification, financial health assessment and incentive application 222 provides an assessment of the financial health of a customer, such as customer 210, and provides an incentive in response to the financial health assessment. The process flows presented in FIGS. 3-4 present examples of some of the potential functionality of a financial health assessment and incentive application.

It will be appreciated that the servers, systems and devices described herein illustrate one embodiment of the invention. It is further understood that one or more of the servers, systems, and devices can be combined in other embodiments and still function in the same or similar way as the embodiments described herein.

FIG. 3 is a flow diagram depicting an example process flow 300 in accordance with an aspect of the invention. As depicted in FIG. 3, the example process flow includes element 310, receiving a first financial behavior set associated with a customer. In example implementation of element 310, information related to the first financial behavior set is received at a system, such as assessment and incentive system 206. In some such implementations, information is received via an interface, such as communication device 212. The information may be in the form of a transmission from a network, such as network 201, or may have been previously stored in a memory device, such as memory device 216. However, it will be appreciated that implementations of element 310 are not limited to the system presented in FIG. 2 and the elements presented there in. Rather, any approach to receiving a first financial behavior set associated with a customer may be used in example implementations of element 310.

The first financial behavior set may be any financial behavior set described herein. For example, the first financial behavior set may include any behavior, goal, action, plan, resource, attribute, characteristic, trait, or other factor that impacts or has the potential to impact the financial health of a customer. In some example implementations of process flow 300, the first financial behavior set may include set elements that are directly attributable to the customer, and elements that are indirectly attributable to the customer. In some implementations of element 310, set elements may be accessible from a customer, such as customer 110 or 210 via a social network that is accessible by an assessment and incentive system, such as social network 203 and assessment and incentive system 206, as shown in FIG. 2. In some example implementations, information available via a customer's social network may also be received and incorporated into a financial behavior set, including but not limited financial information and/or information related to financial information that a customer and/or individuals in a customer's social network may provide. For example, if a customer posts information about their job, recent purchases, vacations, vehicle, hobbies, and/or other activities that involve financial activities and/or behaviors, that information may be incorporated into a financial behavior set. In some example implementations, information such as credit bureau data may be retrieved and incorporated into a financial behavior set. In example implementations where a customer uses a personal financial management application to assist in managing their finances, data and other information associated with the personal financial management application could be incorporated into a financial behavior set. Further, any publicly available information and/or other information provided by or associated with a customer may be used. For example, information shared during a telephone call with a financial institution, presented on the Internet, distributed in publications, or otherwise made available may be incorporated into a financial behavior set. It will be appreciated that any behaviors, goals, actions, plans, resources, attributes, characteristics, traits, or other factors that impact or have the potential to impact the financial health of a customer may be included in a financial behavior set.

In some additional example implementations, the first financial behavior set includes a spending behavior, a savings behavior, a financial goal associated with the customer, a budgeting behavior, or a credit behavior, or any combination such aspects. In some of these example implementations, and other example implementations, the first financial behavior set includes a behavior associated with an individual, wherein the individual is socially affiliated with the customer via a social network.

As used herein, the term spending behavior refers to any expenditure of money, including, but not limited to one-time expenditures, recurring expenditures, and one or more patterns of expenditures. The term savings behavior refers to any allocation of money that tends to preserve or set aside money, including but not limited to placing money in a savings account, investment account, and or otherwise setting aside funds. A financial goal, as used herein, refers to any aim, goal, expectation, intention, or aspiration held by the customer relating to money. For example, a financial goal may be a target balance in an account, a particular credit score, a target retirement date, an intended cash flow, a desired purchase, and/or any other measure of financial worth or health. As used herein, the term budgeting behavior refers to any action or inaction regarding the allocation of money, including but not limited to a balance or imbalance of cash flows, plans for spending and/or saving, the assignment of particular funds to a particular purpose, and/or any other behavior related to the balance or imbalance of financial assets, liabilities, obligations, and/or plans. The term credit behavior used herein refers to any behavior related to the payment and/or nonpayment of money owed by a customer to another entity. Such credit behaviors include, but are not limited to, the timing and/or timeliness of payments made to bills, the incursion and/or repayment of debts, including loans, credit card bills, utility bills, revolving accounts, and/or any other credit account.

In some implementations of element 310 of process flow 300, the first financial behavior set associated with the customer includes a behavior associated with an individual or group of individuals, where that individual or group of individuals is socially affiliated with the customer via a social network. In such implementations, the behavior associated with the individual or group of individuals may be any behavior described herein. For example, such behaviors include, but are not limited to, the tendency of a customer's classmates to incur heavy credit card debt, the retirement age of a parent of the customer, a neighbor's default on a mortgage, a coworker's investment strategy, and/or cash flows associated with a customer's close friends.

As depicted in FIG. 3, element 310 includes receiving a first financial behavior set associated with the customer. In some example implementations of element 310, receiving the first financial behavior set associated with a customer includes obtaining information associated with a plurality of accounts wherein the plurality of accounts comprises a first account associated with a first institution, and a second account associated with a second institution. As used herein, the first institution may be any entity that maintains, administers, or otherwise has knowledge of an account. For example, the first institution may be a financial institution, such as a bank, credit card company, investment brokerage and/or other entity that provides financial goods or services. As used herein, the second institution may be any entity described in relation to the first institution, and may, but need not be, the same type of entity as the first institution in any given implementation. In some such implementations, the customer supplies the information and/or grants permission to view the information. For example, a customer may provide an account statement, a current or past balance of an account, a response to a question regarding the customer's financial behaviors, and/or other information.

In some example implementations of element 310, information related to the first financial behavior set is processed to determine a set of qualitative and/or quantitative ratios. In some example implementations, such ratios may include the ratio of the customer's debt to income, savings to income, savings to spending, timely bill payments to untimely bill payments and/or other ratios that compare one aspect of the first financial behavior set to another aspect of the first financial behavior set. Other example ratios include the ratio of an individual's credit score to the average credit score of a segment of a population, a ratio of investments of one type to investments of another type, and a ratio of credit card payments to credit card balances.

FIG. 3 also depicts element 320, which includes identifying one or more differences between the first financial behavior set and a second financial behavior set. In some example implementations of element 320, the second financial behavior set is stored in data storage as part of a memory device, such as data storage 218 and memory device 216, as shown in FIG. 2. In other example implementations of element 320, the second financial behavior set is received from a network or social network, such as networks 201 and social network 203. In some such implementations, the second financial behavior set is retrieved by an assessment and incentive system that is able to actively seek and acquire computer readable data from a network, such as assessment and incentive system 206, shown in FIG. 2. In some such implementations, a processor, such as processing device 214 compares the information associated with the first financial behavior set to the information associated with the second financial behavior set. In some such implementations, the results generated by the processor may be stored in a memory device such as memory device 216 or transmitted to a network via a communication interface, such as network 201 and communication device 212. However, while some example implementations of element 320 may utilize the assessment and incentive system 206 within the environment 200, it will be appreciate that any approach to identifying one or more differences between the first financial behavior set and a second financial behavior set may be used in implementations of element 320.

The second financial behavior set may include any of the aspects described herein with regard to financial behavior sets, including, but not limited to the aspects of the first financial behavior set. In some example implementations, the second financial behavior set includes a spending behavior, a savings behavior, a financial goal associated with the customer, a budgeting behavior, and/or a credit behavior. In these and other implementations of element 320, the second financial behavior set includes a financial behavior set associated with an individual wherein the individual is socially affiliated with the customer via a social network.

In these, and some other example implementations of element 320, the second financial behavior set may represent a set of behaviors correlated with good financial health, and the second financial behavior set may be specifically tailored to the customer and/or individuals similarly situated to the customer. In other examples, the second financial behavior set includes behaviors that are exhibited by a person who is socially affiliated with the customer and exhibits a more desirable financial health status than the customer.

In some example implementations of element 320, information related to the second financial behavior set is processed to determine a set of qualitative and/or quantitative ratios. For example, such ratios may include the ratio of an individual's debt to income, savings to income, savings to spending, timely bill payments to untimely bill payments and/or other ratios that compare one aspect of the second financial behavior set to another aspect of the second financial behavior set. Other example ratios include the ratio of an individual's credit score to the average credit score of a segment of a population, a ratio of investments of one type to investments of another type, and a ratio of credit card payments to credit card balances. In some implementations of element 320, the second financial behavior set includes a plurality of target ratios, indicating ratios that are correlated with good financial health. In some implementations, the plurality of target ratios represents one or more goal ratios associated with the customer, establishing a guide for a customer attempting to exhibit improved financial behaviors.

Element 330, as shown in FIG. 3, includes providing to the customer an incentive to make an alteration to a financial behavior in the first financial behavior set, wherein the incentive is configured to reduce the one or more differences between the first financial behavior set and the second financial behavior set. In some example implementations of element 330 that are implemented in environment 200, the assessment and incentive system 206 maintains information regarding one or more incentives in data storage 218. In accordance with an implementation of computer readable instructions 220 and an implementation of financial health and incentive system 222, the processing device 214 retrieves the information regarding an incentive from the memory device 216 and passes the information to the communication device 212. In some such implementations, the information regarding an incentive is passed from communication device 212, which is shown as a component of assessment and incentive system 206, to the customer 210 via network 201. The assessment and incentive system 206 may also present the information regarding an incentive to a user of the assessment and incentive system 206, or pass the information via network 201 to another system configured to implement the incentive. For example, in situation where the assessment and incentive system is controlled by a financial institution and the incentive is a monetary award, the assessment and incentive system may present information to the individuals and systems associated with the financial institution to ensure that the monetary award is posted to an account associated with the customer 210 and/or sent to customer 210.

While some implementations of element 330 may use implementations of the environment 200, it will be appreciated that any approach to providing to the customer an incentive to make an alteration to a financial behavior in the first financial behavior set, wherein the alteration to the financial behavior in the first financial behavior set reduces the one or more differences between the first financial behavior set and the second financial behavior set may be used in implementations of element 330.

In some example implementations of element 330, the incentive provided to the customer includes, but is not limited to, a reduced interest rate on a loan, an opportunity to enter a prize drawing, forgiveness of a fee charged on an account, and/or an award, such as a monetary award and/or award points. For example, in some example implementations, a customer who engages in a particular action is provided with an incentive in the form of eligibility for a lottery, wherein the customer may be potentially award a prize in the form of money and/or other items and the pool of eligible entrants in the lottery is limited to those customers who engage in the particular activity and/or otherwise meet a predetermined set of criteria. In some other example implementations, the incentive is an advertisement, such as an advertisement for a product or service that may be attractive to the customer. In some example implementations, the incentive may be constructed such that a benefit associated with the incentive is conferred upon another individual or group. For example, if a customer engages in an improved behavior such as increasing their savings and/or paying bills on time, after a predetermined interval wherein the customer engages in the improved behavior on a regular basis, a prize may be awarded to a family member, or a donation may be made to a charitable organization selected by the customer. It will be appreciated that the incentive may take the form of a potentially negative occurrence. For example, the failure of a customer to reach a goal or improve a behavior may result in an award being presented to a rival of the customer. In some such examples, customer who fails to change and/or improve a behavior may be penalized by being notified of an award being provided to a current or former significant other, or other person within the customer's social network. In another example, a penalty may take the form of preventing a friend or relative from receiving an award or other incentive. In such example implementations, a customer and people within the customer's social network may coordinate efforts to encourage the customer to improve a behavior, ensure that a penalty is not incurred, and/or attempt to be mutually accountable to ensure that a desired goal is achieved or an award is secured. In some other example implementations, the incentive may take the form of a competition between the customer and another individual in the customer's social network. For example, an award may be provided to the first individual who successfully achieves and maintains a particular behavior (e.g. saving a particular percentage of income over a period of time, paying all bills on time for a series of months, etc).

However, it will be appreciated that any incentive that tends to encourage or induce a customer to make an alteration to a financial behavior in the first financial behavior set may be used in implementations of element 330.

FIG. 4 depicts a flow diagram of process flow 400, which presents an example method in accordance with an aspect of the invention. Element 410, which includes receiving a first financial behavior set associated with a customer, is included in process flow 400. Example implementations of element 410 may include, but are not limited to, any of the examples and aspects described herein with respect to element 310 of FIG. 3, or any other implementation of receiving a first financial behavior set associated with a customer.

Also shown is element 420, which includes identifying one or more differences between the first financial behavior set and a second financial behavior set. Example implementations of element 420 may include, but are not limited to, any of the examples and aspects described herein with respect to element 310 of FIG. 3, or any other implementations of identifying via a computing device processor one or more differences between the first financial behavior set and a second financial behavior set.

FIG. 4 also depicts element 430, which includes providing to the customer an incentive to make an alteration to a financial behavior in the first financial behavior set, wherein the incentive is configured to reduce the one or more differences between the first financial behavior set and the second financial behavior set. Example implementations of element 430 may include, but are not limited to, any of the examples and aspects described herein with respect to element 330 of FIG. 3, or any other implementations of providing to the customer an incentive to make an alteration to a financial behavior in the first financial behavior set, wherein the incentive is configured to reduce the one or more differences between the first financial behavior set and the second financial behavior set.

As shown at element 440, the process flow 400 includes, responsive to providing to the customer an incentive to make an alteration to a financial behavior in the first financial behavior set, wherein the incentive is configured to reduce the difference between the first financial behavior set and the second financial behavior set, receiving a third financial behavior set, wherein the third financial behavior set is associated with the customer, and identifying one or more differences between the third financial behavior set and the second financial behavior set.

In some example implementations of element 440, the third financial behavior set represents a reevaluation of the financial health of the customer, and provides an indication of whether the incentive provided to the customer in element 430 has had an effect on the financial health of the customer. Any of the aspects of a financial behavior set described herein may be used in implementations of the third financial behavior set, and implementations of receiving the third financial behavior set may include any of the aspects of receiving a financial behavior set described herein, including, but not limited to the aspects described in relations to element 310 of FIG. 3 and element 410 of FIG. 4. In example implementations of element 440, any aspect of identifying a difference between the third financial behavior set and the second financial behavior set described herein may be used, including, without limitation, any of the aspects described in relation to element 320 of FIG. 3 and element 420 of FIG. 4.

As depicted in FIG. 4, element 450 includes, responsive to identifying one or more differences between the third financial behavior set and the second financial behavior set, adjusting the incentive provided to the customer. In some example implementations of element 450, a difference between the third financial behavior set and the second financial behavior is an indicator regarding the effectiveness of the incentive provided to the client in reducing the difference between a financial behavior set associated with the customer and a second financial behavior set. In some such implementations, the incentive may be increased to provide a stronger incentive to the customer. In some other implementations, an alternate or additional incentive may be provided to the customer to test the effectiveness of an incentive, or to incentivize a different change in behavior.

In some implementations of element 450, an assessment and incentive system, such as assessment system 206 responds to identifying one or more differences between the third financial behavior set and the second financial behavior set by accessing data regarding the incentive previously provided to the customer from memory device 216 and/or network 201. In some such examples, the processing device 216 executes instructions contained in the computer readable instructions 220 and/or the financial health and incentive application 222 to adjust the incentive. The adjusted incentive can then be provided to the customer, using any of the approaches described herein, including, but not limited to, the approaches discussed in relation to element 330 in FIGS. 3 and 430 in FIG. 4.

In some example implementations of element 450, the incentive is adjusted by a matter of degree. For example, if the incentive is a monetary award, a reduced interest rate, and/or a partially forgiven fee, the incentive may be adjusted to be a larger monetary award, a further reduced interest rate, or a larger portion of a forgiven fee. In some other example implementations, adjusting the incentive includes a qualitative change to the incentive. For example, in the first incentive was an opportunity to enter a prize drawing, the adjusted incentive may be an advertisement. In another example, if the first incentive was a waiver of a fee to start a particular account, the adjusted incentive may be an improved contractual term associated with that account. However, it will be appreciated that any adjustment to the incentive may be used in implementations of element 450.

As depicted in FIG. 4, the element 460 includes, in response to identifying one or more differences between the first financial behavior set and a second financial behavior set, directing an advertisement to the customer. In some implementations of element 460, a difference between the first financial behavior set and the second financial behavior set may indicate that a financial product or service, or other good or service, may be attractive to the customer. In such implementations, an advertisement for a potentially attractive good or service may be directed to the customer. In some situations, identifying a difference between a first financial behavior set and a second financial behavior set may reveal that a customer is paying a high interest rate on a loan or credit card account, or is receiving a low interest rate on a savings account, or is otherwise utilizing a good or service perceived as inferior to another good or service. In implementations of element 460, an advertisement for product or service such as a lower-interest loan, a credit card with the opportunity to acquire rewards, a higher interest savings account, or another good or service that is potentially attractive to the customer may be provided.

In some example implementations of element 460 that occur in environments similar to environment 200, the assessment and incentive system 206 acquires information associated with an advertisement from data storage 218 in memory device 216 and/or acquires information regarding an advertisement from the network 201. In some such implementations, processing device 214 executes instructions that cause the assessment and incentive system 206 to transmit the information associated with the advertisement to the customer via communication device 212 and the network 201. While some implementations of element 460 use the system and environment depicted in FIG. 2 and/or a similar system and environment, it will be appreciated that any approach to in response to identifying one or more differences between the first financial behavior set and a second financial behavior set, directing an advertisement to the customer may be used.

Also depicted in FIG. 4 is element 470, which includes identifying a plurality of individuals wherein each individual in the plurality of individuals is socially affiliated with the customer via a social network and directing the advertisement to an individual in the plurality of individuals. As discussed herein, some aspects of example embodiments of the invention contemplate that behaviors observable in a customer's social network may share a degree of commonality with the financial behaviors of the customer. Some implementations of element 470, contemplate a degree of commonality between the goods and/or services that may be attractive to a customer and the goods and services that may be attractive to individuals in the customer's social network. In such implementations, in addition to directing an advertisement to the customer, the same advertisement is directed to one or more individuals within the customer's social network. It will be appreciated that any of the approaches to directing an advertisement to the customer's social network may be used and/or modified to direct the advertisement to the customer's social network. For example, in situations where both the customer and the customer's social network is coupled to a network such as network 201 in FIG. 2, a transmission from an assessment and incentive system such as assessment and incentive system 206 may be sent via a network to both the customer and the customer's social network.

As described herein with respect to FIG. 3 and FIG. 4, some example implementations contemplate obtaining information associated with a customer. Some such implementations may occur in situations where obtaining the information requires efforts on the part of an entity to seek out, gather, and/or compile information from multiple sources. In some of these implementations, and in other example implementations, the information associated with the customer is saved such that the information associated with the customer does not need to be re-acquired in subsequent iterations of an implementation. For example, data associated with a customer could be stored in data storage included in a memory device, such as data storage 218 in memory device 216. Some example implementations that contemplate saving the information associated with the customer include: receiving a first financial behavior set associated with a customer; identifying one or more differences between the first financial behavior set and a second financial behavior set; providing to the customer an incentive to make an alteration to the first financial behavior set wherein the alteration to the first financial behavior set reduces the one or more differences between the first financial behavior set and the second financial behavior set; and storing the first financial behavior set associated with the customer. Some of these implementations and some other example implementations also contemplate periodically receiving an update to the first financial behavior set and storing the update to the first financial behavior set. It will be appreciated that other information may also be stored, including but not limited to information associated with additional financial behavior sets. For example, and additional financial behavior set that is stored could include, but is not limited to, the financial behavior sets discussed herein with respect to process flow 300 of FIG. 3 and process flow 400 of FIG. 4.

Some example implementations contemplate recognizing a behavior and/or the potential for a behavior and notifying the customer and/or individuals in the customer's social network. For example, if a customer has a history of missing a due date for a particular bill or set of bills, a notification may be transmitted to the customer via e-mail, text message, voice call, or other means when the bill is nearly due. In some example implementations, a notification may also be transmitted to individuals in the customer's social network to encourage such individuals to remind the customer to pay the bill or bills on time.

In other example implementations, a customer's location may be taken into account. For example, if a customer has previously overspent at a particular store or other business, location information, such as location information obtained from a customer's mobile phone, may be used to recognize that the customer is at or near the particular store, and cause a notification to be sent to the customer's mobile device. Such a notification may include an incentive to encourage the customer to leave the store and/or engage in responsible behaviors in the store. In some such example implementations, a notification may be sent to individuals in the customer's social network alerting the individuals to the potential for the customer to engage in a negative behavior, and encourage the individuals to help the customer engage in an alternate behavior.

### Explanatory Example

For the purposes of explanation, and without limitation, the following example implements many aspects of the invention:

In an effort to assess the financial health of a customer and incentivize improved financial behaviors, a bank invites a customer who holds a checking account and a mortgage at the bank to answer a series of questions about the customer's financial activities, interests, goals, and background information. The customer subsequently submits responses to the questions along with account statements describing accounts held with other financial institutions. Upon receiving this information, the bank recognizes that while the customer is exhibiting many positive financial behaviors, the customer is earning a very low interest rate on a savings account with another financial institution and occasionally uses their personal credit card, issued by a different institution, for expenses incurred by a small business owned by the customer which causes the customer to maintain a high credit card balance. The information received by the bank also indicates that the customer lives in a neighborhood where several homeowners have recently defaulted on their mortgages. The bank compares the received information, which is an example of a financial behavior set associated with the customer, to a model financial behavior set that incorporates information and behavioral targets regarding individuals similarly situated to the customer, such as the customer's neighbors, other small business owners, and individuals with background and asset profiles similar to the customers. The bank's computer system compares the financial behavior set associated with the customer to the model financial behavior set and identifies several differences between the financial behavior sets. In response to identifying such differences, an advertisement for a credit card with features tailored for small businesses is sent to the customer. Similar advertisements are sent owners of small businesses who are members of the same community service organization that the customer leads.

Among the identified differences between the financial behavior set associated with the customer and model financial behavior set is the relatively high number of individuals in the customer's neighborhood who have defaulted on their mortgage and the customer's occasional late payment of the customer's own mortgage. In response to identifying these differences, the bank provides an incentive to the customer, wherein for every month that the customer submits their mortgage payment on time, the bank will reduce the interest rate on the mortgage. After some time has passed, the bank observes that the customer has continued to pay their mortgage on time, and offers an additional incentive, wherein the customer is entered into a drawing for the chance to win a free consultation with a small business advisor.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for assessing and incentivizing a financial behavior associated with a customer, the apparatus comprising:
a computing device comprising a memory and at least one processor; and
a customer financial behavior assessment application stored in memory, executable by the processor, and configured to:
receive a first financial behavior set comprising a spending behavior associated with a customer;
identify one or more differences between the first financial behavior set and a second financial behavior set comprising a target spending behavior;
determine location information associated with the customer;
determine, from the first financial behavior set, that the customer has previously exhibited undesired spending behavior at a location corresponding to the location information associated with the customer;
in response to determining the customer has previously exhibited undesired spending behavior at the location, provide to the customer a notification that the customer has previously exhibited undesired spending behavior at the location; and
in conjunction with the notification, provide to the customer an incentive to make an alteration to a financial behavior in the first financial behavior set, wherein the incentive is configured to reduce the one or more differences between the first financial behavior set and the second financial behavior set.

2. The apparatus of claim 1 wherein customer financial behavior assessment application is further configured to obtain information associated with a plurality of accounts wherein the plurality of accounts comprises a first account associated with a first institution, and a second account associated with a second institution.

3. The apparatus of claim 1 wherein the first financial behavior set comprises at least one aspect selected from the group consisting of a savings behavior, a financial goal associated with the customer, a budgeting behavior, and a credit behavior.

4. The apparatus of claim 1 wherein the first financial behavior set comprises a behavior associated with an individual, wherein the individual is socially affiliated with the customer via a social network.

5. The apparatus of claim 1 wherein the second financial behavior set comprises at least one aspect selected from the group consisting of a spending behavior, a savings behavior, a financial goal associated with the customer, a budgeting behavior, and a credit behavior.

6. The apparatus of claim 1 wherein the second financial behavior set comprises a financial behavior set associated with an individual wherein the individual is socially affiliated with the customer via a social network.

7. The apparatus of claim 1 wherein the financial behavior assessment application is further configured to offer the customer at least one incentive selected from the list consisting of: a reduced interest rate on a loan, an opportunity to enter a prize drawing, forgiveness of a fee charged on an account, and an award.

8. The apparatus of claim 1, wherein the financial behavior assessment application is further configured to:
receive a third financial behavior set, wherein the third financial behavior set is associated with the customer; and
identify one or more differences between the third financial behavior set and the second financial behavior set.

9. The apparatus of claim 8 wherein the financial behavior assessment application is further configured to:
in response to identifying one or more differences between the third financial behavior set and the second financial behavior set, adjust the incentive provided to the customer.

10. The apparatus of claim 1 wherein the financial behavior assessment application is further configured to:
in response to identifying one or more differences between the first financial behavior set and a second financial behavior set, direct an advertisement to the customer.

11. The apparatus of claim 10 wherein the financial behavior assessment application is further configured to:
identify a plurality of individuals wherein each individual in the plurality of individuals is socially affiliated with the customer via a social network; and
direct the advertisement to an individual in the plurality of individuals.

12. A method for assessing and incentivizing a financial behavior associated with a customer, the method comprising:
receiving a first financial behavior set comprising a spending behavior associated with a customer;
identifying via a computing device processor one or more differences between the first financial behavior set and a second financial behavior set comprising a target spending behavior;
determining location information associated with the customer;
determining, from the first financial behavior set, that the customer has previously exhibited undesired spending behavior at a location corresponding to the location information associated with the customer;
in response to determining the customer has previously exhibited undesired spending behavior at the location, providing to the customer a notification that the customer has previously exhibited undesired spending behavior at the location; and
in conjunction with the notification, providing to the customer an incentive to make an alteration to a financial behavior in the first financial behavior set, wherein the incentive is configured to reduce the one or more differences between the first financial behavior set and the second financial behavior set.

13. The method of claim 12 wherein receiving the first financial behavior set associated with a customer comprises obtaining information associated with a plurality of accounts wherein the plurality of accounts comprises a first account associated with a first institution, and a second account associated with a second institution.

14. The method of claim 12 wherein the first financial behavior set comprises at least one aspect selected from the group consisting of a spending behavior, a savings behavior, a financial goal associated with the customer, a budgeting behavior, and a credit behavior.

15. The method of claim 12 wherein the first financial behavior set comprises a behavior associated with an individual, wherein the individual is socially affiliated with the customer via a social network.

16. The method of claim 12 wherein the second financial behavior set comprises at least one aspect selected from the group consisting of a spending behavior, a savings behavior, a financial goal associated with the customer, a budgeting behavior, and a credit behavior

17. The method of claim 12 wherein the second financial behavior set comprises a financial behavior set associated with an individual wherein the individual is socially affiliated with the customer via a social network.

18. The method of claim 12 wherein providing to the customer an incentive to make an alteration to a financial behavior in the first financial behavior set, wherein the alteration to the financial behavior in the first financial behavior set reduces the difference between the first financial behavior set and the second financial behavior set comprises offering the customer at least one incentive selected from the list consisting of: a reduced interest rate on a loan, an opportunity to enter a prize drawing, forgiveness of a fee charged on an account, and an award.

19. The method of claim 12, the method further comprising:
responsive to providing to the customer an incentive to make an alteration to a financial behavior in the first financial behavior set, wherein the alteration to the financial behavior in the first financial behavior set reduces the difference between the first financial behavior set and the second financial behavior set:
receiving a third financial behavior set, wherein the third financial behavior set is associated with the customer; and
identifying via a computing device processor one or more differences between the third financial behavior set and the second financial behavior set.

20. The method of claim 19 further comprising:
responsive to identifying via a computing device processor one or more differences between the third financial behavior set and the second financial behavior set, adjusting the incentive provided to the customer.

21. The method of claim 12 further comprising:
in response to identifying via a computing device processor one or more differences between the first financial behavior set and a second financial behavior set, directing an advertisement to the customer.

22. The method of claim 21 further comprising:
identifying a plurality of individuals wherein each individual in the plurality of individuals is socially affiliated with the customer via a social network; and
directing the advertisement to an individual in the plurality of individuals.

23. A computer program product comprising:
a non-transitory computer-readable medium comprising:
a first set of codes for causing a computer processor to be configured for receiving a first financial behavior set comprising a spending behavior associated with a customer;
a second set of codes for causing a computer processor to be configured for identifying via a computing device processor one or more differences between the first financial behavior set and a second financial behavior set comprising a target spending behavior;
a third set of codes for causing a computer processor to be configured for determining location information associated with the customer;
a fourth set of codes for causing a computer processor to be configured for determining, from the first financial behavior set, that the customer has previously exhibited undesired spending behavior at a location corresponding to the location information associated with the customer;
a fifth set of codes for causing a computer processor to be configured for, in response to determining the customer has previously exhibited undesired spending behavior at the location, providing to the customer a notification that the customer has previously exhibited undesired spending behavior at the location; and
a third set of codes for causing a computer processor to be configured for, in conjunction with the notification, providing to the customer an incentive to make an alteration to a financial behavior in the first financial behavior set, wherein the incentive is configured to reduce the one or more differences between the first financial behavior set and the second financial behavior set.
